(19) United States
(12) Patent Application Publication
(10) Pub. No.: US 2015/0192400 A1
(43) Pub. Date: Jul. 9, 2015

(54) Handheld Measuring Device

(71) Applicant: Robert Joseph Rado, Highland, NY (US)

(72) Inventor: Robert Joseph Rado, Highland, NY (US)

(21) Appl. No.: 14/581,212

(22) Filed: Dec. 23, 2014

Related U.S. Application Data
(60) Provisional application No. 61/923,299, filed on Jan. 3, 2014.

(51) Int. Cl. G01B 5/04

(52) U.S. Cl. CPC G01B 5/043

(57) ABSTRACT

A handheld measuring device is provided that facilitates measurement of elongated articles such as wire, rope, cable, tubing, and the like. The device includes a housing having an upper and a lower roller that are adapted to bear against an article to be measured. The lower roller is connected to a counter assembly and the upper roller is rotatably supported within a clevis and affixed to a plunger assembly. A spring biased locking mechanism locks the plunger assembly in place as the article to be measured is drawn between the rollers. The counter assembly registers a linear distance traveled by the lower roller for accurate measurement of the work piece. The device can be deployed in one hand and is suitable to be carried on one's person when not in use. The housing facilitates insertion of a work piece while the rollers and clevis member prevent separation from the rollers.

### CROSS REFERENCE TO RELATED APPLICATION

This application claims the benefit of U.S. Provisional Application No. 61/923,299 filed on Jan. 3, 2014, entitled “Roller Measure.” The above identified patent application is herein incorporated by reference in its entirety to provide continuity of disclosure.

### BACKGROUND OF THE INVENTION

1. Field of the Invention

The present invention relates to rope and wire measuring devices, whereby lengths thereof are measured using a journaled roller that can measure the distance traveled along the wire such that accurate measurements and cuts thereof can be taken. More specifically, the present invention relates to tools of the handheld type that are capable of measuring lengths of flexible, elongated members whereby the tool of the present invention is well adapted for single-hand use.

Construction workers and other individuals who regularly install elongated, flexible lengths of material such as electrical wiring, cables, and flexible tubing, generally measure out the length of the particular item being installed such that a given span can be accommodated. Measuring an accurate length to traverse the desired distance is simpler for rigid work piece articles, whereby a tape measure can be positioned along the length of the work piece and the article does not change shape over its elongated span. By contrast, measuring lengths of flexible members is not always as easy.

Many types of flexible members are transported on spools, and therefore the members have an inherent curve in their shape until they are stretched or installed. Therefore, applying a measuring tape to flexible members is not always the most accurate or straightforward tasks for an installer. The flexibility of the article and any curve therein makes accurate measurements using a linear scale difficult. Inaccurate measurements can result in inappropriate cuts of material, which can make for wasted material or inadequately sized lengths thereof to accommodate the installation. Therefore, most common methods deployed include over-measuring the length of wire, cable, or the like, wherein excess can be trimmed thereafter. This, however, also creates wasted product in the form of smaller scrap that cannot be reused.

The present invention contemplates an improved measuring device in the form of a handheld tool. The device comprises a journaled lower roller and an adjustable upper roller, whereby the rollers sandwich the work piece therebetween and the journaled roller can accurate measure the length of the work piece as the tool is moved along the length thereof. The construction of the device is such that it can be deployed using one-hand and stowed on one's person when not in use. This allows for rapid deployment when installing electrical wiring, cables for different applications, flexible tubing, and other flexible items that have an elongated length which may be otherwise difficult to measure with a tape measure or ruler. Overall, the device saves product by ensuring more accurate measurements, and also prevents wasted time and guess work related to required lengths of material for a specific job.

2. Description of the Prior Art

Devices have been disclosed in the prior art that relate to rope and wire measuring devices. These include devices that have been patented and published in patent application publications. These devices generally relate to larger apparatuses that are statically deployed on a workbench or in a production environment. The present invention contemplates a small, handheld tool for measuring flexible lengths of a material work piece. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 1,038,797 to Sommerfield, which discloses a rope measuring device that utilizes a framework fixed to a desired position, wherein a V-shaped pulley wheel and a coil spring are used to bear against rope pulled through the device. The shaft of the pulley is journaled to a worm gear that engages a dial face. The dial face registers the linear distance traveled by the pulley for measuring the length of rope pulled through the framework. The Sommerfield device, while providing a means to measure rope, fails to provide a handheld tool or one that share the same construction as the present invention. The present invention is a personal hand tool that is not fixed to a support, but rather secured to the rope itself and used to measure lengths thereof as the device is rolled along the rope length.

Another device is U.S. Pat. No. 1,225,128 to Heimark, which discloses another rope measuring device using a fixed assembly. The Heimark device comprises an open casing with a guide slot, a rope guide roller, and a shaft that is driven by a hand crank. An indicator dial is mounted to the casing and to a transmission gearing, whereby the distance traveled by the roller via the hand crank is measurable by the user. The Heimark device fails to address a need for a more portable hand tool as contemplated by the present invention. Notably, the present invention is operated in the hands of a user and rolled along the length of an elongated member, such as rope, wiring, or the like. No permanent supports are necessary or contemplated, and the housing of the present invention is sufficiently compact to be handheld and carried on one's person if necessary.

Similar to the Heimark and Sommerfield devices is U.S. Pat. No. 1,350,894 to Thiel. The Thiel device is used to measure rope distances using a similar framework and pulley assembly. A first a second pulley are used to tension a rope therebetween, wherein a hand crank is provided for advancing the rope therethrough. A measuring means is used to measure the distance traveled of the pulley and thus the length of rope fed through the assembly. Here again, the Thiel device is a large apparatus that is supported on a work surface and one not suited for handheld use in the field.

It is clear from the foregoing that there exists a need in the art for a handheld length measuring device that can measure rope, wiring, and other flexible members without resorting to a large, statically supported apparatus that cannot be easily transported or deployed to a worksite. It is submitted that the present invention substantially fulfills these needs by providing an assembly that can be advanced along a length of flexible material, or vice versa, and used to measure lengths thereof for accurate cutting. The present invention is small enough to be held in one hand and supported from a tool belt when not in use. The prior art describes larger frameworks and housings that are impractical in the environment contemplated by the present invention.

It is submitted that the present invention is substantially diverges in design elements from the prior art, and consequently it is clear that there is a need in the art for an improvement to existing rope and wire measuring devices. In this regard the instant invention substantially fulfills these needs.

### SUMMARY OF THE INVENTION

In view of the foregoing disadvantages inherent in the known types of measuring tools now present in the prior art, the present invention provides a new handheld measuring tool that can be utilized for providing convenience for the user when elongated lengths of flexible material such as wire, rope, cables, tubing and the like.

It is therefore an object of the present invention to provide a new and improved handheld measuring device that has all of the advantages of the prior art and none of the disadvantages.

It is another object of the present invention to provide a handheld measuring device that can be used to measuring accurate lengths of flexible wire, cable, cord, or similar material that is otherwise difficult to measuring with a straight ruler or measuring tape.

Another object of the present invention is to provide a handheld measuring device that can be deployed with a single hand while supporting the flexible work piece with a second hand as it moves through the device.

Yet another object of the present invention is to provide a handheld measuring device that is adapted to clamp a work piece between a first and second roller, whereby the first roller is journaled to a linear measurement display that can be used to count the length of material that passes between the two rollers.

Another object of the present invention is to provide a handheld measuring device that retains a material work piece between the two rollers using pressure on the work piece and optionally an extended clevis fitting supporting the upper roller, whereby the work piece is retained between the extents of the clevis while the measurement activity is undertaken.

Another object of the present invention is to provide a handheld measuring device that includes a latchable plunger connected to the upper roller, whereby the distance between the two rollers can be adjusted and locked into a permanent state to sandwich a work piece therebetween.

Another object of the present invention is to provide a handheld measuring device that includes a spring biased locking mechanism to release the plunger and separate the two rollers.

Another object of the present invention is to provide a handheld measuring device that is contained within a small housing, whereby the housing is readily transportable and handled in the field, while also providing ease of placement of a material work piece centrally therein and between the rollers.

A final object of the present invention is to provide a handheld measuring device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead perspective view of the present invention in a working state, being used to measure an elongated, flexible article.

FIG. 2 shows an end view of the present invention in a working state.

FIG. 3 illustrates the single-handedness of the present invention and the optional side-opening of the housing.

FIG. 4 shows an illustrative cross sectional view of the present invention and a close-up view of the two rollers and the extended clevis fitting of the upper roller.

### DETAILED DESCRIPTION OF THE INVENTION

Reference is made herein to the attached drawings. Like reference numerals are used throughout the drawings to depict like or similar elements of the handheld measuring device of the present invention. For the purposes of presenting a brief and clear description of the present invention, the preferred embodiment will be discussed as used for measuring elongated, flexible work piece articles in which linear lengths are otherwise difficult to measure using a ruler or tape measure device. The figures are intended for representative purposes only and should not be considered to be limiting in any respect.

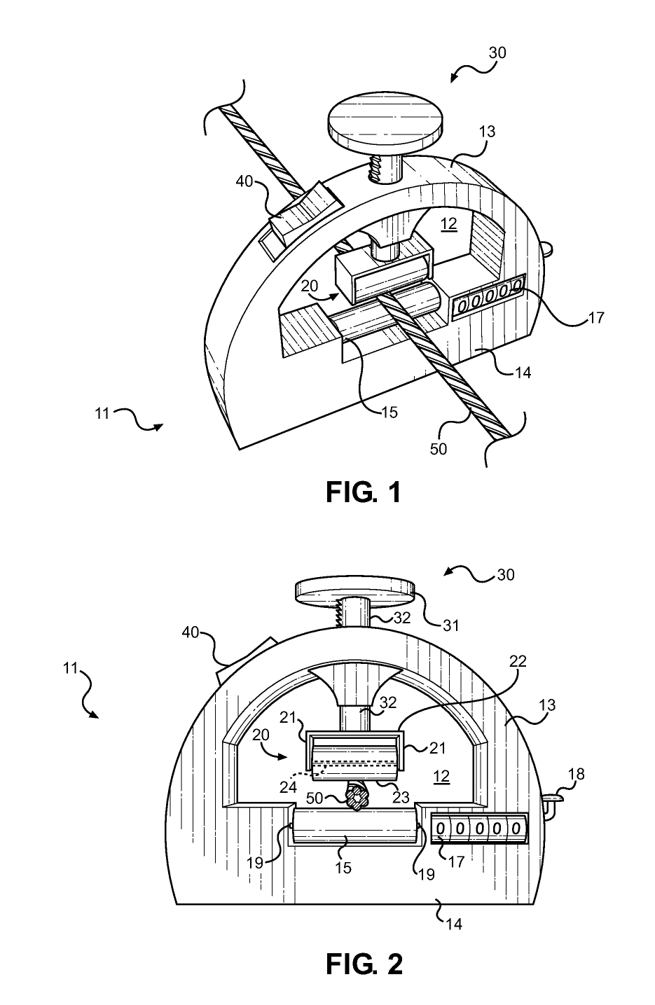

Referring now to FIGS. 1 and 2, there are shown two views of the handheld measuring tool of the present invention. The device comprises a housing 11 having a lower portion 14 and an upper portion 13. Between the upper 13 and lower 14 portions is an open interior portion 12, which is adapted to receive an elongated work piece 50 therethrough and support the measuring elements of the device. The open interior portion 12 extends through the interior of the housing 11 and allows a work piece to slide therethrough. The front and rear surfaces of the open interior portion 12 are open, while the sides thereof are bounded (or partially bounded) by the housing lower portion 14 and upper portion 13.

Disposed along the lower portion 14 and along the base of the open interior portion 12 is a lower roller 15. The lower roller 15 is a cylindrical member supported along an axle 19 that is journaled or otherwise in contact with a counter assembly 17. The lower roller 15 comprises an outer surface and a diameter, whereby the static circumference of the roller is used as a measurement tool that is counted by the counter assembly 17 with each rotation thereof. The counter assembly 17 registers linear distance traveled by the roller, whereby a series of dials having indicia are used as an indicator for the user when measuring a work piece 50. The significant figures provided on the dial are determined based on the accuracy of the counter assembly in contact with the lower roller, whereby small linear increments can be measured for more precise measurements, and/or larger lengths of a work piece can be measured with fewer significant figures. It is not desired to limit the present invention to a given level of accuracy or lowest measurable unit, but rather to contemplate an assembly that may be used for both large scale and smaller scale measurements of linear distance along the article 50.

Disposed within the open interior portion 12 is an adjustable upper roller 23. The upper roller 23 is rotatably supported along an axle 24 that is affixed between the arms 21 of a clevis assembly 20. The clevis 20 is statically connected to an elongated member 32 that extends through and is supported within the upper portion 13 of the housing 11. The elongated member 32 is part of a plunger assembly 30 that is lockably positioned within the housing open interior 12 and that is adapted to provide lockable distance adjustment of the upper roller 23 with respect to the lower roller 15.

The plunger assembly 30 comprises a depressible upper surface 31, an elongated member 32, and a plurality of notches disposed along the elongated member 32 that are used to lock the plunger assembly 30 into a static configuration. The notches form a ladder strap style connection with a spring biased locking mechanism within the housing upper portion 13. The locking mechanism comprises a spring biased latch and slider 40 that is biased against the notches of the elongated member 32. The latch of the mechanism engages one or more of the notches to secure the plunger assembly 30 in a static configuration. This allows the upper roller 23 and the lower roller 15 to define a static distance therebetween, which is used to sandwich a work piece article 50 being measured.

In use, the upper roller 23 and lower roller 15 sandwich an article 50 therebetween and the article is pulled through the housing 11 and over the rollers. The upper roller 23 rotates freely while the lower roller 15 rotates the counter assembly 17. The counter assembly 17 registers the linear distance traveled along the article 50 in a given increment and unit system. The housing 11 can be moved along the work piece or vise verse to obtain a measurement, whereby the desired length of the article can be determined for subsequent work thereupon (e.g. cutting, trimming, etc.). A counter reset switch 18 is provided to zero out the counter when necessary.

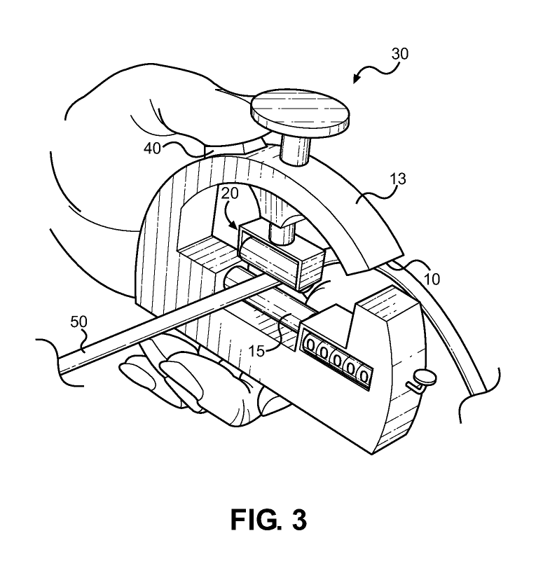

Referring now to FIG. 3, there is illustrated a view of the device being handled and used in a single hand. The upper roller and lower roller, which are both rigid, cylindrical members, sandwich an elongated work piece 50 so that linear distance therealong can be measured without resorting to a tape measure or ruler tool. The clevis assembly 20 supports the freely rotating upper roller, while the lower roller 15 is engaged with the counter assembly to register the distance traveled by the lower roller 15. Adequate compression of the work piece 50 between the rollers ensures no slipping at the interface between the rollers and the work piece, thereby ensuring an accurate measurement. The rollers are sufficient supported via an axle and bearing elements within the housing that force required to slide the rollers is minimized, albeit dependent upon the friction and force applied to the work piece (e.g. the provided distance between the rollers when accommodating the work piece).

One embodiment of the housing contemplates a side opening 10, which allows the work piece 50 to be inserted into the open interior portion of the housing anywhere along its length and not only at one of its terminal ends. This allows the housing to engage and couple to the work piece anywhere along its length and not limit inserting of the work piece to one of its free ends. Once inserted, the work piece is clamped between the rollers by depressing the plunger assembly 30. Once adequate bearing pressure is applied to the work piece 50 and the plunger 30 has been locked in a static position, the work piece 50 can be drawn through the housing and over the rollers to register a length thereof. When releasing the work piece 50, the slider 40 can be used to release the internal locking mechanism holding the plunger assembly 30 in place, thereby allowing the roller to separate from one another and provide clearance to remove the work piece. A marking tool or writing instrument can be used to mark the work piece 50 while still engaged with the rollers, whereby an accurate cut can be made at the point when the desired length is registered by the counter.

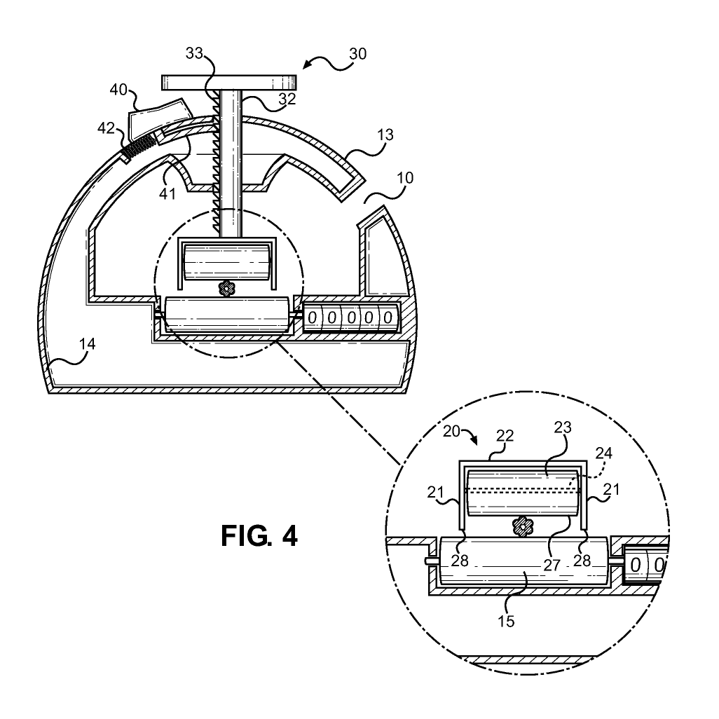

Referring now to FIG. 4, there is shown a cross sectional view of the handheld tool of the present invention. As shown, the notches 33 of the elongated member 32 are engaged by a latch member 41 and used to retain the plunger assembly 30 in a static configuration relative to the housing. The latch 41 bears into the elongated member 32 and the notches 33 prevent sliding of the plunger assembly 30 when the latch 41 is engaged. A spring biased locking mechanism is comprised of a linear coil spring 42 that biases the latch 41 into the elongated member 32. A slider 40 is connected to the latch 41 and can be slidably moved along the housing to compress the spring 42 and release the latch 41 from the notches of the elongated member 32. In its resting state, the spring 42 biases the latch 41 into the elongated member 32, while the user can slide the slider 40 away from the elongated member 32 to release the plunger assembly 30.

The housing of the present invention may comprise a substantially hollow or solid member, whereby the lower portion 14 supports the lower roller 15 and the upper portion 13 supports the plunger assembly 30 and locking mechanism. Along the upper portion 13 may further be provided a side opening 10, whereby the upper portion 13 is not continuous around the open interior portion of the housing. This allows a work piece to be inserted through the upper portion and through the side thereof, as opposed to inserted via a free end thereof through an enclosed open interior portion.

Referring to the close-up view of the clevis assembly 20 and the rollers, an embodiment of the clevis assembly 20 is shown. The clevis assembly 20 comprises an upper surface 22 and a pair of clevis arms 21 that form a U-shape surrounding the upper roller 23. An axle 24 extends between the arms 21 and rotatably supports the upper roller 23 thereon. In some configurations the lower extent 28 of the clevis arms 21 may be greater than or less than the lower extent 27 of the upper roller 23. If greater, the clevis arms 21 have a greater length than the diameter of the roller 23 and thus extend lower than the roller 23. The extended arms enclose a work piece therebetween and ensure the work piece does not slide laterally along the roller 23 and become decoupled therewith. However, this slightly limits the smallest diameter work piece to be just greater than the exposed portion of the clevis arms 21 below the upper roller lower extent 27. Both the extended and non-extended embodiments are contemplated, wherein the former provides an additional feature of retaining a work piece between the rollers when in use measuring the length thereof.

The present invention provides a stable way to measure rope, wire, cable, or similar flexible or elongated items. The device reduces the risk of dropping or losing control of the object or improperly measuring the article. Overall, the device saves time and frustration measuring elongated items and flexible articles. The device provides a hand held tool that measures a length of an article by pulling the same through the rollers of the device, which are clamped against the article by depressing the graduated plunger and locking the same with the spring biased locking mechanism. The lower roller is connected to a counter assembly and preferably measures in increments of at least one eighths of an inch. The upper roller spins freely to feed the work piece through the device, while the plunger is depressed to secure the work piece in place while the same is being measured.

The housing is preferably constructed of a lightweight material such as plastic, while the counter assembly includes a rotating set of dials to display the measured distance that can be reset as needed. The plunger assembly is preferably constructed of a plastic or aluminum material with a rubber upper roller disposed within the clevis assembly. The housing maybe constructed in a number of ways and with known methods in the art of tool construction, whereby one construction comprises a housing with a first and second half glued, screwed, or otherwise fastened together to form one enclosed handheld device.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A handheld measuring device, comprising:
a housing having an upper portion, a lower portion, and an open interior portion;
an upper roller and a lower roller;
said lower roller rotatably supported within said lower portion and connected to a counter assembly that registers linear distance traveled as said lower roller rotates;
a clevis assembly within said open interior portion and supporting said upper roller such that said upper roller freely rotates with respect to said clevis member;
said clevis assembly supported by an elongated member that is vertically slidable and statically lockable within said upper portion;
said upper roller disposed above said lower roller to define a gap therebetween;
said gap adapted to receive a work piece and be sandwiched between said upper roller and lower roller, said upper roller and said lower roller adapted to rotate as said work piece is pulled through said gap.

2. The handheld measuring device of claim 1, further comprising:
a locking mechanism within said upper portion of said housing;
said locking mechanism comprising a coil spring, a latch member, and a slider;
said latch member biased against said elongated member via said coil spring to lock said elongated member in a static position relative to said upper portion;
said slider being slidably positioned within said upper portion and adapted to operably compress said coil spring to retract said latch member from said elongated member.

3. The handheld measuring device of claim 1, wherein:
said elongated member further comprises a plurality of notches therealong;
said plurality of notches adapted to receive a latch member for locking said elongated member in a static position relative to said upper portion.

4. The handheld measuring device of claim 1, wherein:
said clevis assembly and said elongated member form a plunger assembly;
said plunger assembly further comprising a depressible upper disposed above said upper portion of said housing.

5. The handheld measuring device of claim 1, wherein:
said clevis assembly further comprises an upper surface and a pair of clevis arms forming a U-shape surrounding said upper roller;
said upper roller being rotatably supported along an axle disposed between said clevis arms.

6. The handheld measuring device of claim 5, wherein:
said pair of clevis arms has a length and a lower extent;
said upper roller has a diameter and a lower extent;
wherein said lower extent of said pair of clevis arms is below said lower extent of said upper roller.

7. The handheld measuring device of claim 1, wherein:
said upper portion further comprises a side opening extending through said upper portion and into said open interior portion.

8. The handheld measuring device of claim 1, wherein said counter assembly further comprises a counter reset switch.
